(19) United States
(12) Patent Application Publication
(10) Pub. No.: US 2021/0189013 A1
(43) Pub. Date: Jun. 24, 2021

(54) METHOD FOR PREPARING PHYSICALLY MODIFIED STARCH BY USING HEATING AND FREEZING-THAWING AND ADDING VARIOUS EDIBLE GUMS

(71) Applicant: Korea University Research and Business Foundation, Seoul (KR)

(72) Inventors: Seung-Taik LIM, Seoul (KR); Chen ZHANG, Seoul (KR)

(73) Assignee: Korea University Research and Business Foundation, Seoul (KR)

(21) Appl. No.: 16/756,236

(22) PCT Filed: Sep. 17, 2018
(86) PCT No.: PCT/KR2018/012248

§ 371 Date: Apr. 15, 2020

(30) Foreign Application Priority Data
Oct. 17, 2017 (KR) 10-2017-0134630
Oct. 17, 2017 (KR) 10-2017-0134631

(51) Int. Cl. C08B 30/06; A23L 29/212; A23L 29/269; A23L 29/238; A23L 29/25; A23L 29/262; A23L 3/365; A23L 3/40

(52) U.S. Cl. CPC C08B 30/06; A23L 29/212; A23L 29/27; A23L 29/238; A23V 2002/00; A23L 29/262; A23L 3/365; A23L 3/40; A23L 29/25

(57) ABSTRACT

The present invention relates to a method for preparing physically modified starch by utilizing heating and freezing-thawing (FT) on starch or a starch-gum mixture obtained by adding gum to starch. According to the method for preparing physically modified starch of the present invention, the weakness of natural starch can be supplemented, and heat and shear stability, gel-forming ability, and storage stability thereof can be improved. Especially, modified starch with a significantly improved modification effect can be produced by the addition of gum and the heating and freezing-thawing treatment. The present invention can significantly improve quality and storage stability of various starchy foods through a simple modification procedure, and thus it is expected that the present invention can be variously utilized in industry field of food including starchy food.

### TECHNICAL FIELD

The present invention relates to a method for preparing a physically modified starch including heating and freezing-thawing (FT) a starch or a starch-gum mixture obtained by adding a gum to a starch.

### BACKGROUND ART

Native starches are not widely utilized in the food industry due to their many disadvantages such as poor stability against heat or shear, aging, formation of unstable pastes and gels, and low storage stability of starch gels. Thus, native starches need to be modified to overcome their disadvantages.

Numerous physical, chemical, enzymatic, and biotechnological methods for starch modification are known. Particularly, chemical methods for starch modification are known because of their ability to best overcome the disadvantages of native starches and to impart excellent characteristics to modified starches. Physical methods for starch modification are considered the safest, easiest, and most cost effective and are advantageous in terms of safety because they leave no chemical residue in final physically modified starches.

Under these circumstances, continuous studies have been conducted on physical starch modification. Representative physical methods for starch modification include heat-moisture treatment (HMT) and annealing (ANN). A number of other physical methods for starch modification have been developed.

Most of the newly developed physical methods for starch modification use machines, involving high cost and limiting their commercialization. Therefore, there is a need for research on simple, cost-effective, and safe physical methods for starch modification.

Starch modification methods based on freezing-thawing have recently been developed and their effects on improving the surface characteristics, crystal structure, swelling power, solubility, and thermal properties of starches were reported.

Starch modification methods based on freezing-thawing are 1) methods including preparing a starch dispersion at 25° C. and freezing-thawing (FT) the starch dispersion, 2) methods including gelatinizing a starch at a very high temperature and freezing-thawing the gelatinized starch, and 3) methods including freezing-thawing a native starch without pretreatment. Another method for starch modification based on freezing-thawing (FT) cycles is known.

When a starch is subjected to freezing-thawing, internal components escape from the starch particles by a force created during the freezing-thawing and external water molecules enter the particles to modify the internal structure of the starch. However, the force induces destruction of the starch particles to deteriorate the thermal stability of the modified starch.

Gums refer to hydrophilic long chained biopolymers with high molecular weight. The addition of a starch-gum mixture to a food improves the rheological properties of the food, imparts a new texture to the food, and improves the quality and stability of the product. Another advantage is cost saving.

Modified starches are most widely used to improve the quality of final products in the food industry. Accordingly, an important consideration is to determine whether the excellent characteristics of modified starches are maintained during processing for manufacturing final products.

Thus, the present inventors have earnestly conducted research to develop a promising method for physically modifying a starch, and as a result, have found that a modified starch prepared by heating and freezing-thawing a starch or a starch-gum mixture has good stability against heat and shear, an outstanding ability to form a gel, and improved gel storage stability. The present invention has been accomplished based on this finding.

### DETAILED DESCRIPTION OF THE INVENTION

### Problems to be Solved by the Invention

The present invention has been made in an effort to solve the problems of native starches and intends to provide a method for preparing a modified starch that has good stability against heat and shear, an outstanding ability to form a gel, and improved storage stability while overcoming the disadvantages of native starches, by heating and freezing-thawing a starch or a starch-gum mixture.

The present invention also intends to provide a method for physically modifying a starch in cost-effective, simple, and safe physical clean-label way to prepare a modified starch that can be used to improve the quality and storage stability of various starchy foods.

Specifically, an object of the present invention is to provide a method for preparing a modified starch including (a) adding a gum to a starch to prepare a starch-gum mixture, (b) heating the starch-gum mixture to a temperature at which no gelatinization of the starch occurs, (c) cooling the heated starch-gum mixture, (d) freezing the cooled starch-gum mixture and thawing the frozen starch-gum mixture at room temperature, and (e) drying the thawed starch-gum mixture.

### Means for Solving the Problems

An aspect of the present invention provides a method for preparing a physically modified starch that has good stability against heat and shear, an outstanding ability to form a gel, and improved storage stability while overcoming the disadvantages of native starches, by adding a gum to a starch and heating and freezing-thawing the starch-gum mixture.

Specifically, the method of the present invention includes (a) heating a starch or a starch-gum mixture obtained by adding a gum to a starch to a temperature at which no gelatinization of the starch occurs, (b) cooling the heated starch or starch-gum mixture, (c) freezing the cooled starch or starch-gum mixture and thawing the frozen starch or starch-gum mixture at room temperature, and (d) drying the thawed starch or starch-gum mixture.

### Effects of the Invention

The method of the present invention enables the preparation of a physically modified starch that has good stability against heat and shear, an outstanding ability to form a gel, and improved storage stability without the disadvantages of native starches. Particularly, the gum addition and the subsequent heating and freezing-thawing are highly effective in starch modification.

In addition, the method of the present invention enables the preparation of a modified starch based on a simple modification. The use of the modified starch greatly contributes to improvements in the quality and storage stability of various starchy foods. Therefore, the modified starch is expected to find application in the food industry, including starchy foods.

### BRIEF DESCRIPTION OF THE DRAWINGS

FIG. 1 is a microscopy image of a pregelatinized starch used in Example 1-1-1 in which the circular birefringence patterns (cruciform) disappeared after gelatinization of the starch.

FIG. 2 shows the shapes and birefringence patterns of modified starch particles observed in Example 1-2-1.

FIG. 3 shows images of native starch particles after heating for 0 h (left) and ≥12 h (right) in Example 1-1-2.

FIG. 4 shows the degrees of dissolution of amylose from modified starches observed in Example 1-2-1.

FIG. 5 shows the surfaces of modified starches observed in Example 1-2-1.

FIGS. 6a to 6d show the pasting viscosities of modified starches measured using an RVA in Example 1-2-2.

FIG. 7 shows total soluble sugars after individual processing steps, which were measured in Example 1-2-4.

FIG. 8 shows blue values representing the amounts of amylose dissolved after individual processing steps, which were measured in Example 1-2-4.

FIG. 9 is a microscopy image of a pregelatinized starch used in Example 2-1-1 in which the circular birefringence patterns (cruciform) disappeared after gelatinization of the starch.

FIG. 10 shows the shapes and birefringence patterns of modified starch particles observed in Example 2-2-1.

FIG. 11 shows the particles of a native starch (left) and the particles of the native starch after heating for ≥12 h (right) in Example 2-1-2.

FIG. 12 shows the degrees of dissolution of amylose from modified starches observed in Example 2-2-1.

FIG. 13 shows the surfaces of modified starches observed in Example 2-2-2.

FIG. 14 shows scanning electron microscopy (SEM) images of the internal structures of modified starch gels observed in Example 2-2-3.

### BEST MODE FOR CARRYING OUT THE INVENTION

Unless otherwise defined, all technical and scientific terms used herein have the same meaning as commonly understood by one of ordinary skill in the art to which this invention belongs. In general, the nomenclature used herein is well known and commonly employed in the art.

In one aspect, the present invention is directed to a method for preparing a physically modified starch including (a) heating a starch or a starch-gum mixture obtained by adding a gum to a starch to a temperature at which no gelatinization of the starch occurs, (b) cooling the heated starch or starch-gum mixture, (c) freezing the cooled starch or starch-gum mixture and thawing the frozen starch or starch-gum mixture at room temperature, and (d) drying the thawed starch or starch-gum mixture.

Herein, the temperature at which no gelatinization of the starch occurs in step (a) refers to a temperature lower than the final gelatinization pasting temperature of the native starch. The final pasting temperature is measured by differential scanning calorimetry (DSC) and may vary depending on the kind of the starch. The temperature at which no gelatinization of the starch occurs is preferably from 35 to 70° C.

The starch may be selected from the group consisting of native and modified cereal, root and tuber crop, rhizome, bean, and fruit starches. The starch is preferably normal corn starch (NCS), waxy corn starch (WCS), potato starch (PS) or tapioca starch (TS). Preferably, the starch is an amylose-containing one.

In step (a), the starch or starch-gum mixture may be heated for 30 minutes to 12 hours. The heating for 30 minutes to 12 hours desirably induces sufficient swelling of the starch particles. As the heating time increases, the amount of amylose dissolved from the starch particles increases and the amounts of the gum and water molecules entering the starch particles increase, thus being effective in modifying the starch. Meanwhile, if the heating time is longer than 12 hours, water is removed by evaporation, which increases the possibility of undesirable gelatinization of the starch.

In step (c), the cooled starch or starch-gum mixture is frozen at a temperature of 0 to −80° C. for at least 30 minutes and the frozen starch or starch-gum mixture is thawed at a temperature of 5 to 70° C., which is lower than the pasting temperature, for 30 minutes to 24 hours. The freezing temperature corresponds to a temperature at which a dispersion of the starch or the starch-gum mixture can be frozen and the thawing temperature corresponds to a temperature at which the frozen starch dispersion or starch-gum mixture can be thawed into a solution. If the starch solution or the starch-gum mixture is frozen for less than 30 minutes, the starch-gum mixture is not completely frozen, which is undesirable. If the thawing temperature is higher than the pasting temperature of the starch, the starch is gelatinized, thus not being effective in modifying the starch. Accordingly, a thawing temperature exceeding 70° C. is not preferable. The thawing time varies depending on the thawing temperature.

In step (a), the starch is in the form of a dispersion. The starch dispersion is prepared by mixing 10 to 60% (w/w) of the starch with water. The starch-gum mixture has a concentration of 10 to 60% (w/w). The starch or starch-gum mixture having a concentration less than 10% (w/w) undergoes layer separation of the starch and the water or layer separation of the starch, the gum, and the water. This layer separation is not effective in modifying the starch. Meanwhile, the starch solution or the starch-gum mixture having a concentration exceeding 60% (w/w) is difficult to prepare.

In step (d), the thawed starch or starch-gum mixture is preferably dried at a temperature of 25 to 70° C. for 5 to 72 hours. The thawed starch or starch-gum mixture should be dried at a temperature where the starch is not gelatinized. Accordingly, a drying temperature exceeding 70° C. is not preferred. The drying time varies depending on the drying temperature.

The drying process is selected from the group consisting of natural drying, freeze-drying, vacuum drying, and drying at constant temperature and humidity, but is not limited thereto.

The gum is a natural gum or a derivative thereof. Sources for the natural gum include plant, microbial, and animal polysaccharides, and proteins. The gum is preferably selected from the group consisting of xanthan gum, guar gum, gum arabic, and carboxymethyl cellulose (CMC). The gum may have a high or low inherent viscosity. That is, the inherent viscosity of the gum is not limited. The gum may be an ionic or non-ionic gum.

In step (a), the starch-gum mixture is prepared by directly mixing a starch with a gum. Alternatively, the starch-gum mixture may be prepared by adding a gum to distilled water, adding the gum solution to a starch to prepare a starch dispersion, and stirring the starch dispersion.

In step (a), the gum is added in an amount of 0.1 to 10% (w/w), based on the weight of the starch. If the gum is added in an amount less than 0.1% (w/w), the effect of adding the gum is negligible. Meanwhile, if the gum is added in an amount exceeding 10% (w/w), the starch-gum mixture becomes highly viscous, making it difficult to prepare the starch-gum mixture.

In a further aspect, the present invention is directed to a modified starch prepared by the method.

The modified starch may be used in food processing without further purification. Other suitable sugars and food additives may be optionally added to the modified starch. Alternatively, the modified starch may be further modified.

In another aspect, the present invention is directed to a food composition including the modified starch. The food is selected from the group consisting of breads, noodles, confectioneries, sauces, sausages, and beverages, but is not limited thereto.

In the Examples section that follows, the effects of the individual processing steps of the method according to the present invention on the modification of starches were evaluated.

In the Examples section that follows, the thermal properties of modified starches were determined by characterization of starch gelatinization (RVA, Newport Scientific Inst., Australia).

In the Examples section that follows, the birefringence patterns of modified starches and the degrees of dissolution of internal components from modified starches were observed using a microscope.

In the Examples section that follows, the surface states of modified starch particles and the internal structures of modified starch gels were observed using a scanning electron microscope (SEM).

In the Examples section that follows, the textures of modified starch gels were determined by TPA.

In the Examples section that follows, the freezing-thawing stability of modified starches were confirmed.

### MODE FOR CARRYING OUT THE INVENTION

### Examples

The present invention will be explained in more detail with reference to the following examples. It will be appreciated by those skilled in the art that these examples are merely illustrative and the scope of the present invention is not construed as being limited to the examples. Thus, the substantial scope of the present invention should be defined by the appended claims and their equivalents.

Materials and Methods

Starches

Corn starch and waxy corn starch received from Samyang Genex (Korea) and potato starch and tapioca starch received from Seoan (Korea) and Daesang (Korea) were used in the following experiments.

Gums

Four kinds of gums, including xanthan gum (XT) (Keltrol, The Nutrasweet Kelco Company, USA), guar gum (GG) (Lotus Gum and Chemicals, India), gum arabic (GA) (The Gum Arabic Company, Sudan), and carboxymethyl cellulose (CMC) (Showa Chemicals, Japan), were used in the following experiments.

### Example 1: Preparation of Modified Starches

1-1: Preparation of Modified Starches

(1) A dispersion of each of normal corn starch (NCS), waxy corn starch (WCS), potato starch (PS), and tapioca starch (TS) was heated to a temperature at which no gelatinization of the corresponding starch occurred (60° C. for normal corn starch and waxy corn starch and 55° C. for potato starch and tapioca starch) (hereinafter referred to as “H”).

(2) The heated dispersion was cooled in a refrigerator for 12 h (hereinafter referred to as “HC”).

(3) The cooled dispersion was frozen in a freezer (−20° C.) for 12 h and thawed at room temperature (25° C.) for 1 h (hereinafter referred to as “HCFT”).

Thereafter, the starch dispersion was dried in a dry oven at 45° C. and powdered. The starch powder was used in the following experiments.

1-1-1: Heating Temperature Setting

The final pasting temperature of each of the native starches was determined by DSC. The native starch was heated at a temperature lower than the final pasting temperature.

The characteristics of the potato starch (PS) after heating at 25° C., 75° C., and an optimal heating temperature of 35 to 70° C. were observed and compared with those of the native starch. There was no substantial difference when the potato starch was heated at 25° C., demonstrating that the heating temperature was not effective in modifying the starch. The viscosity of the potato starch heated at 75° C. was very low compared to that of the native starch (peak viscosity (PV) and final viscosity (FV)) and the degree of aging of the potato starch after gelatinization was very high compared to that of the native starch (setback viscosity (SV)). The best pasting characteristics were observed when the starch was heated at the optimal heating temperature (35-70° C.) (Table 1).

TABLE 1

| | | Viscosity (mPa · s) | | | | |
|---|---|---|---|---|---|---|
| Sample | | PV | BV | FV | SV | PT (° C.) |
| PS | Native starch | 8226 ± 2 | 6178 ± 1 | 2773 ± 4 | 725 ± 7 | 66.9 ± 0.0 |
| | 25° C. | 7990 ± 3 | 6056 ± 2 | 2699 ± 10 | 765 ± 6 | 65.3 ± 0.0 |
| | 75° C. | 5915 ± 3 | 4010 ± 7 | 1021 ± 2 | 884 ± 1 | 62.0 ± 0.8 |

| | | | | | |
|---|---|---|---|---|---|
| Optimal heating temperature | 8167 ± 1 | 4404 ± 1 | 3930 ± 7 | 167 ± 5 | 71.0 ± 0.0 |

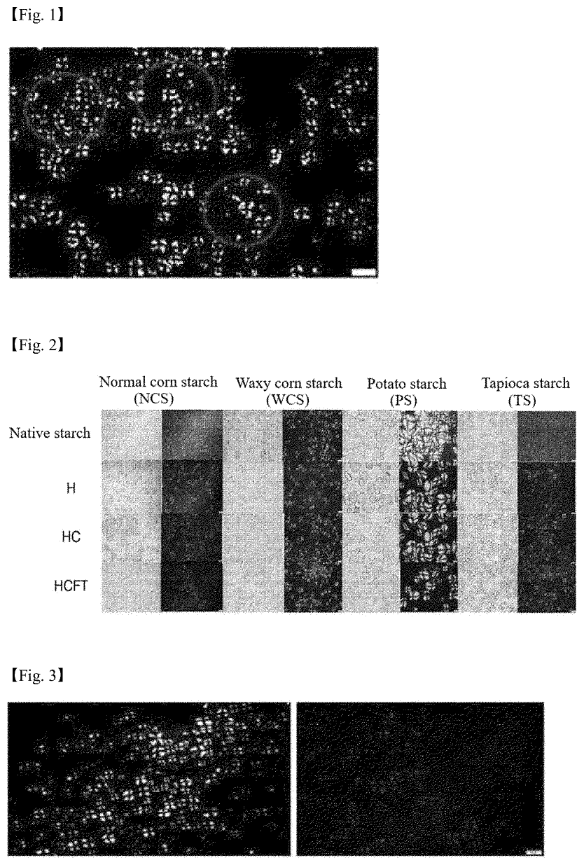

The birefringence patterns of the starch disappeared after gelatinization (FIG. 1), but clear cruciform birefringence patterns were observed in the native starch heated at the optimal heating temperature (FIG. 2).

1-1-2: Heating Time Setting

After heating of the starch solution for 30 min to 12 h, sufficient swelling of the starch particles was observed.

The characteristics of the normal corn starch (NCS) after heating for 30 min, 14 h, and an optimal heating time of 35 min to 12 h were observed and compared with those of the native starch. As a result, the stability of the normal corn starch after heating for 30 min was improved compared to that of the native starch (breakdown viscosity (BV)) and the degree of aging of the normal corn starch after gelatinization was very low compared to that of the native starch (SV). In addition, the viscosity of the normal corn starch after heating for ≥12 h was very low compared to that of the native starch (PV, FV), the stability of the normal corn starch during gelatinization was very low compared to that of the native starch (BV), and the degree of aging of the normal corn starch after gelatinization was high compared to that of the native starch (SV). The best pasting characteristics were observed when the normal corn starch was heated for the optimal heating time (30 min to 12 h) (Table 2).

TABLE 2

| | | Viscosity (mPa · s) | | | | |
|---|---|---|---|---|---|---|
| Sample | | PV | BV | FV | SV | PT (° C.) |
| PS | Native starch | 8226 ± 2 | 6178 ± 1 | 2773 ± 4 | 725 ± 7 | 66.9 ± 0.0 |
| | Heating for 30 min | 8009 ± 2 | 5400 ± 7 | 3019 ± 3 | 410 ± 4 | 83.0 ± 0.8 |
| | Heating for 14 h | 5927 ± 3 | 4930 ± 9 | 1807 ± 4 | 810 ± 3 | 83.0 ± 0.8 |

| | | | | | |
|---|---|---|---|---|---|
| Optimal heating time | 8167 ± 1 | 4404 ± 1 | 3930 ± 7 | 167 ± 5 | 71.0 ± 0.0 |

As the heating time increases, the amount of amylose dissolved from the starch particles increases and the amount of water molecules entering the starch particles increases, thus being effective in modifying the starch. Meanwhile, if the heating time is longer than 12 hours, water is removed by evaporation, which increases the possibility of undesirable gelatinization of the starch.

After heating for >12 h, the clear cruciform birefringence patterns disappeared (FIG. 3).

1-2: Characterization of the Modified Starches

1-2-1: Surface States and Birefringences of the Control Starch Particles and the Modified Starch Particles and Degrees of Dissolution of Internal Components from the Control Starch Particles and the Modified Starch Particles

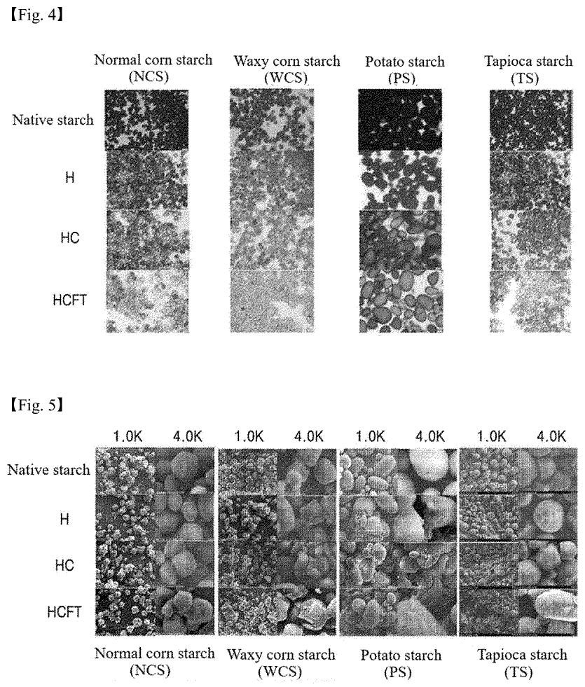

The birefringences of the control starch particles and the modified starch particles after the processing steps (1), (2), and (3) were observed by light microscopy (CX40-32J02/CX-POL, Olympus, Tokyo, Japan). The birefringences were clearly observed in the modified starches prepared in all processing steps. The degrees of dissolution of internal components from the modified starches after HCFT were higher than those from the untreated control native starches and those from the modified starches after H and HC (FIGS. 2 and 4).

The surfaces of the modified starch particles after the processing steps (1), (2), and (3) were observed using an ultra-high resolution scanning electron microscope (HR-SEM, Hitachi SU-70, Tokyo, Japan).

As a result, the surfaces of the native starches were found to be very smooth. Larger numbers of pores with larger depth were observed on the surfaces of the corn starch (WCS and NCS) particles after the individual processing steps, particularly HCFT. The surfaces of the waxy corn starch (WCS) particles after the individual processing steps were damaged. The WCS particles were broken after the individual processing steps. Based on these observations, the pasting viscosity of the modified waxy corn starch (WCS) was predicted to be very low. The potato starch (PS) particles and the tapioca starch (TS) particles aggregated to form clusters after the individual processing steps. Particularly, the starch particles more clearly surrounded the surfaces of the particles after HCFT (FIG. 5).

1-2-2: Viscosities of the Control Starch Pastes and the Modified Starch Pastes

The viscosities of the untreated control native starch pastes and the modified starch pastes after the individual processing steps were measured using a rapid viscoanalyzer (RVA) (Newport Scientific Inst., Australia) in accordance with the protocol (No. 1) provided by the manufacturer (initial and final temperatures: 50° C., 95° C. was maintained for 3 min, total analysis time: 15 min). The concentrations of the modified starch pastes were adjusted to 70% (2.1 g with respect to the weight of each paste (30 g)).

The peak viscosity (PV), breakdown viscosity (BV), and setback viscosity (SV) values of the four starches after H were low compared to the respective native starches. Particularly, the final viscosity (FV) values of the potato starch (PS) and the tapioca starch (TS) used in the above experiment increased significantly compared to those of the respective native starches.

The highest peak viscosity (PV), breakdown viscosity (BV), and setback viscosity (SV) values were obtained after HCFT.

The breakdown viscosity (BV) and setback viscosity (SV) values of starch particles represent the thermal and shear stability of the starch particles. Lower BV and SV values of particles indicate that the particles are less likely to break during heating. The potato starch was found to undergo the greatest reduction in breakdown viscosity (BV).

Setback viscosity (SV) represents aging. The SV values of the three starches other than the waxy corn starch (WCS) decreased after the individual processing steps, demonstrating that the aging of the three starches was suppressed by the processing steps. Particularly, HCFT most significantly suppressed the aging of the three starches.

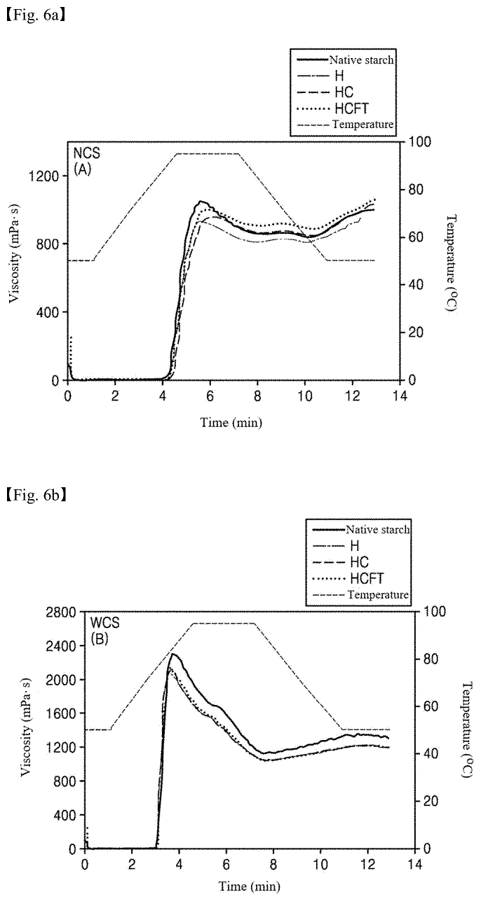

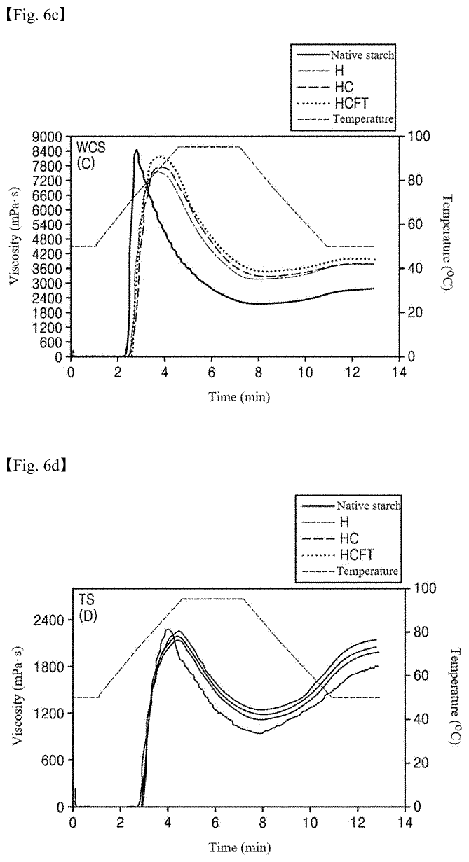

HCFT induced more changes in pasting characteristics. HCFT significantly increased the final viscosities (FV) and significantly reduced the breakdown viscosities (BV) and setback viscosities (SV) compared to H and HC (FIG. 6).

1-2-3: Textures of the Control Starch Gels and the Modified Starch Gels

The textures of the starch gels were measured using a texture analyzer (TA) (TA-XT2, Stable Micro Systems, Surrey, UK). The gels of the three starches other than the waxy corn starch (WCS) showed very different textures after the individual processing steps. The hardness, springiness, cohesiveness, and chewiness of the starch gels were greatly improved after the individual processing steps. The potato starch (PS) showed the greatest change in texture. Particularly, the textures of the modified starch gels after HCFT were most markedly improved. The cohesiveness of a starch gel represents its structural stability. The springiness of a material represents the elasticity of the material when deformed and the ability of the material to absorb energy applied, i.e. the resistance of the material to deformation. The modified starch gels after HCFT showed the best structural stability, the highest deformation resistance, and the best storage stability (the highest syneresis during storage) (Table 3).

TABLE 3

| | Sample¹⁾ | Hardness (g) | Springness (mm) | Cohesiveness | Chewiness (g) |
|---|---|---|---|---|---|
| NCS | Native (control starch) | 23.80 ± 1.54^{a} | 0.17 ± 0.00^{a} | 0.18 ± 0.00^{a} | 0.71 ± 0.02^{a} |
| Normal | H | 33.53 ± 0.5^{b} | 0.22 ± 0.01^{b} | 0.20 ± 0.01^{a} | 1.41 ± 0.02^{b} |
| corn starch | HC | 42.13 ± 0.55^{c} | 0.25 ± 0.02^{bc} | 0.22 ± 0.01^{b} | 2.19 ± 0.06^{c} |
| | HCFT | 48.90 ± 0.90^{d} | 0.27 ± 0.02^{c} | 0.24 ± 0.01^{c} | 3.17 ± 0.52^{d} |
| WCS | Native (control starch) | 34.93 ± 0.95^{b} | 0.38 ± 0.03^{a} | 0.40 ± 0.02^{ab} | 5.57 ± 0.33^{a} |
| Waxy | H | 33.16 ± 0.15^{a} | 0.39 ± 0.02^{a} | 0.38 ± 0.00^{a} | 5.41 ± 0.14^{a} |
| corn starch | HC | 33.83 ± 0.12^{ab} | 0.38 ± 0.03^{a} | 0.38 ± 0.01^{a} | 5.49 ± 0.13^{a} |
| | HCFT | 33.53 ± 1.40^{ab} | 0.41 ± 0.02^{a} | 0.41 ± 0.01^{b} | 5.58 ± 0.83^{a} |
| PS | Native (control starch) | 246.83 ± 2.90^{a} | 0.83 ± 0.01^{a} | 0.83 ± 0.01^{a} | 158.14 ± 4.60^{a} |
| Potato starch | H | 299.73 ± 0.46^{b} | 0.88 ± 0.00^{b} | 0.88 ± 0.00^{b} | 228.93 ± 2.07^{b} |
| | HC | 328.33 ± 9.72^{c} | 0.87 ± 0.01^{b} | 0.89 ± 0.02^{c} | 230.00 ± 1.00^{b} |
| | HCFT | 397.33 ± 1.91^{d} | 0.92 ± 0.01^{c} | 0.93 ± 0.01^{d} | 331.06 ± 7.01^{c} |
| TS | Native (control starch) | 73.43 ± 0.87^{a} | 0.60 ± 0.01^{a} | 0.57 ± 0.02^{a} | 24.46 ± 0.71^{a} |
| Tapioca starch | H | 87.87 ± 0.23^{b} | 0.66 ± 0.01^{b} | 0.68 ± 0.01^{b} | 49.82 ± 0.29^{b} |
| | HC | 114.33 ± 1.75^{c} | 0.68 ± 0.02^{c} | 0.71 ± 0.02^{c} | 51.88 ± 1.63^{c} |
| | HCFT | 121.55 ± 2.18^{d} | 0.71 ± 0.00^{d} | 0.77 ± 0.01^{d} | 66.82 ± 0.85^{d} |

1-2-4: Amounts of Amylose Dissolved from the Starches and Total Soluble Sugars in the Starches

The amounts of amylose dissolved from the starches after the individual processing steps in Example 1-1 and total soluble sugars in the starches were measured. The total soluble sugars in the potato starch (PS) before and after the individual processing steps were measured by the phenol-H2504 method. The blue values of amylose leached from the potato starch (PS) before and after the individual processing steps were measured. As a result, the amounts of amylose dissolved from the starch particles after the individual processing steps were larger than that from the native starch (FIGS. 7 and 8), indicating that the starch modification steps were all effective. When a larger amount of amylose is dissolved from starch particles, a larger amount of water molecules enter the starch particles. The water molecules are converted to ice crystals when frozen, with the result that significant internal modification of the starch particles occurs.

### Example 2: Preparation of Gum-Added Modified Starches

2-1: Preparation of Modified Starches

Based on the results of Example 1, the potato starch (PS) was selected and used as the control native starch in the subsequent experiments because its characteristics were excellent compared to the other 3 starches.

First, a starch-gum mixture was prepared. The starch-gum mixture was modified in the same manner as in Example 1-1.

(1) The starch-gum mixture was heated for 1 h at a temperature (55° C.) where the potato starch was not gelatinized, and cooled in a refrigerator for 12 h (hereinafter referred to as “HC”).

(2) The cooled starch-gum mixture was frozen in a freezer (−20° C.) for 12 h and thawed at room temperature (25° C.) for 2 h (hereinafter referred to as “HCFT”).

Thereafter, the thawed starch-gum mixture was dried in a dry oven at 45° C. and powdered. The powder was used in the following experiments.

The starch was mixed with a gum in predetermine ratios, and each of the mixtures was dried in a dry oven (hereinafter referred to as “Mix-dry”). The dried mixture was used as a first control. The starch-gum mixture was subjected to freezing-thawing without heating (hereinafter referred to as “FT”) to demonstrate the necessity and importance of the starch heating step. The thawed mixture was used as a second control. A starch dispersion was prepared without gum and subjected to freezing-thawing without heating (hereinafter referred to as “FT”). The thawed mixture was used as a third control.

In order to enhance the efficiencies of the starch and the gum, the starch-gum mixture was obtained by the following procedure. First, 0.1-10% (w/w) of the gum with respect to the weight of the starch was slowly added to strongly stirred distilled water. Then, the starch was added to the gum solution, followed by stirring at room temperature. The starch-gum mixture was used in this experiment. Alternatively, the gum may be used in the form of particles.

2-1-1: Heating Temperature Setting

The final pasting temperature of each of the starch-gum mixtures was determined by DSC. The starch-gum mixture was heated to a temperature lower than the measured final pasting temperature.

When the starch-gum mixture was heated to the optimal heating temperature of potato starch (PS) (35-70° C.), the best pasting characteristics were obtained.

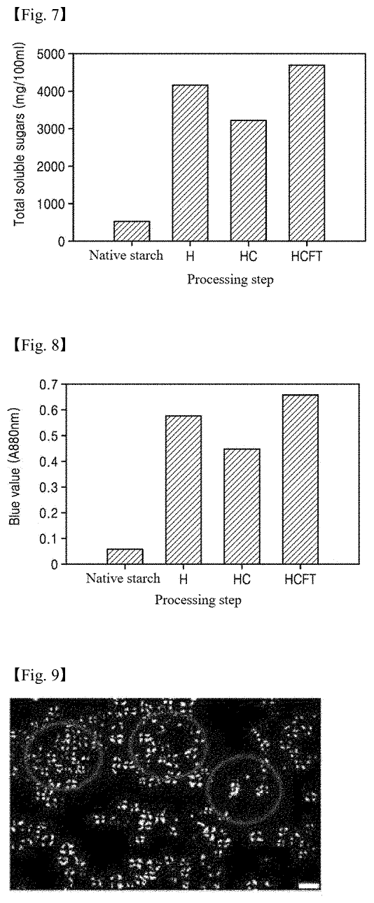

Once the starch has been gelatinized, the birefringence patterns of the starch disappeared (FIG. 9). When heated to the optimal heating temperature, clear cruciform birefringence patterns were observed (FIG. 10).

2-1-2: Heating Time Setting

When heated for 30 min to 12 h, sufficient swelling of the starch-gum mixture was observed.

When the starch-gum mixture was heated for the optimal heating time (30 min to 12 h), the best pasting characteristics were obtained.

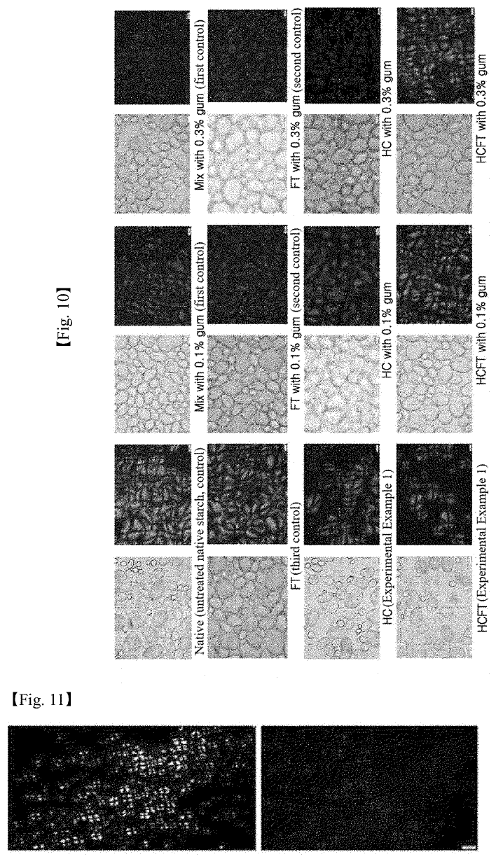

As the heating time increases, the amount of amylose dissolved from the starch particles increases and the amount of water molecules entering the starch particles increases, thus being effective in modifying the starch. Meanwhile, if the heating time is longer than 12 hours, water is removed by evaporation, which increases the possibility of undesirable gelatinization of the starch. After heating for >12 h, the clear cruciform birefringence patterns of the native starch disappeared (FIG. 11).

2-2: Characteristics of the Modified Starches

2-2-1: Degrees of Dissolution of Internal Components from the Control Starch Particles and the Modified Starch Particles

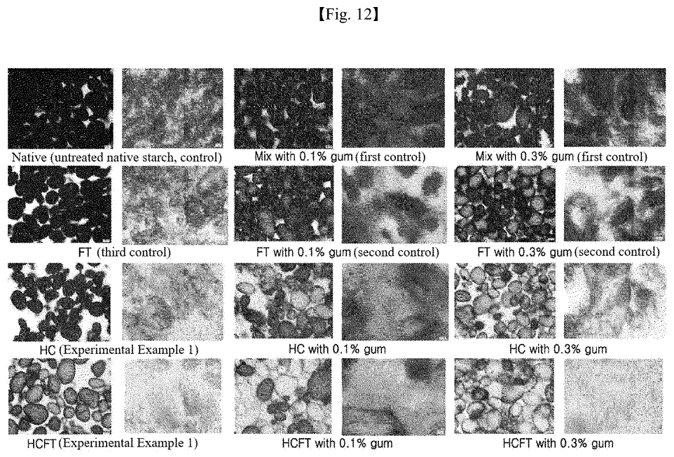

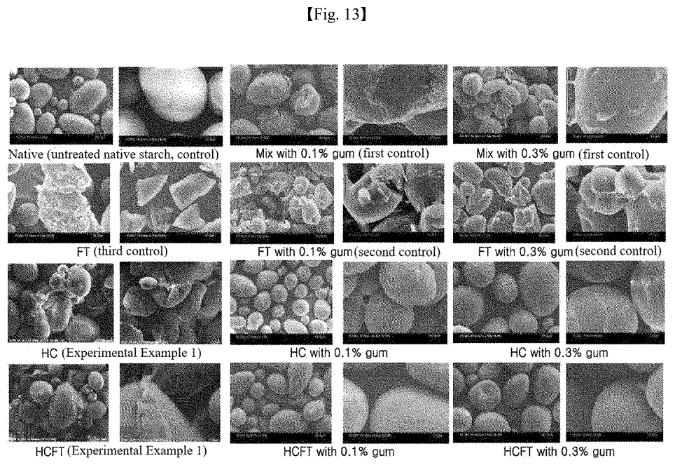

The degrees of dissolution of internal components from the modified starches prepared in Example 2-1 were determined using a microscope (CX40-32J02/CX-POL, Olympus, Tokyo, Japan). The internal states of the gum-added modified starches were very transparent compared to those of the gum-free control starches, which is because the starch particles were coated with the added gum or internal components were dissolved from the starch particles by the individual processing steps. Therefore, the coating of the starch particles with the added gum is predicted to improve the thermal stability of the modified starch. There were no significant differences in the degree of dissolution depending on the proportion and the kind of the gum added (FIGS. 10 and 12).

2-2-2: Surface Observation of the Control Starch Particles and the Modified Starch Particles

The surfaces of the modified starches were observed using an ultra-high resolution scanning electron microscope (HR-SEM, Hitachi SU-70, Tokyo, Japan).

For the third control (FT), the starch particles were broken after the processing. That is, a force created during freezing without pretreatment (heating) caused damage to and breakage of the starch particles. The images of the third control (FT) taken at 1.0 K reveal that the broken starch particles aggregated to form large clusters. This is believed to be because when the starch particles were broken, amylose and amylopectin as the internal components and the broken starch particles aggregated, resulting in low starch stability and gel storage stability.

For the second control (FT), no breakage of the starch particles was found irrespective of the proportion and kind of the gum added, but deformation of the starch particles was observed. This is believed to be because the gum was coated on the surface of the starch particles to prevent the particles from being significantly damaged by a force created during freezing and only the morphology of the particles was deformed.

For Mix-dry, small shells were formed on the surface of the starch particles irrespective of the proportion and kind of the gum added. The formation of the shells is possibly because the gum or its mixture with the dissolved amylose is coated and dried on the surface of the starch particles. The surface state of the starch particles after HC was similar to that after Mix-dry.

Most interestingly, the surface of the particles after HCFT was very smooth, like that of the untreated control native starch used in Example 1-1. From these observations, it could be confirmed that the gum was located inside the starch particles as well as on the surface of the particles. An outward force created by the resistance of the gum located inside the particles to the force created during the processing steps, particularly the freezing step, is similar to a force applied to the starch particles by the low temperature during the freezing. This explains the smooth surface of the starch particles indicate high stability of the particles (FIG. 13).

2-2-3: Internal Structures of the Control Starch Gel and the Modified Starch Gels

The internal structures of the modified starch gels were observed using an ultra-high resolution scanning electron microscope (HR-SEM, Hitachi SU-70, Tokyo, Japan). The internal structures of the gum-added modified starch gels were much denser and more robust irrespective of the kind of the gum than those of the gum-free untreated control native starch, the modified starches after HC and HCFT in Example 1-1 and the modified starches after FT (third control) in Example 2-1, demonstrating very high storage stability of the gum-added modified starch gels.

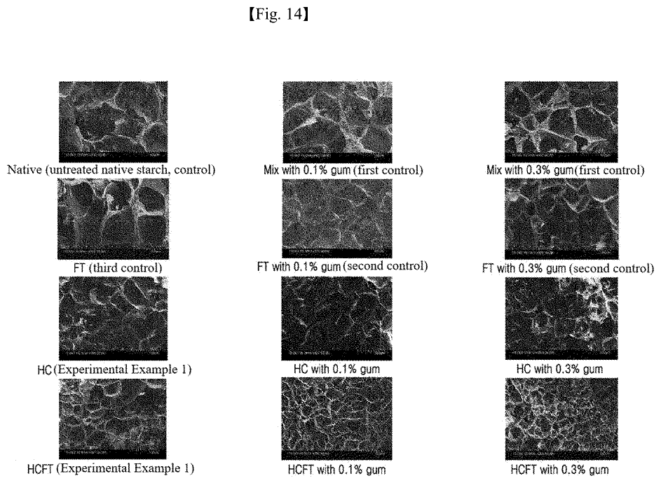

In addition, the internal structures of the 0.3% gum-added gels had denser and much smaller cells than the 0.1% gum-added starch gels. The internal structures of the 0.3% gel-added modified starches after HCFT were most stable (FIG. 14).

2-2-4: Viscosities of the Control Starch Paste and the Modified Starch Pastes

The viscosities of the control starch paste and the modified starch pastes were measured using a rapid viscoanalyzer (RVA) (Newport Scientific Inst., Australia) in accordance with the protocol (No. 1) provided by the manufacturer (initial and final temperatures: 50° C., 95° C. was maintained for 3 min, total analysis time: 15 min). The concentration of each of the pastes was adjusted to 7.0% (2.1 g with respect to the weight of each paste (30 g)).

The gum-added pastes after Mix-dry, HC, HCFT, and FT (second control) had lower breakdown viscosities (BV) and setback viscosities (SV) and higher final viscosities (FV) than the gum-free control native starch, the modified starches after HC and HCFT in Example 1-1, and the modified starches after FT (third control) in Example 2-1 irrespective of the kind of the gum. In conclusion, the gum addition increased the inhibitory effect on aging and the ability to resist heat or shear.

In addition, the 0.1% gum addition decreased the peak viscosity (PV), breakdown viscosity (BV) and setback viscosity (SV) compared to the 0.3% gum addition. However, there was were significant differences in final viscosity (FV) between the 0.1% gum addition and the 0.3% gum addition.

Particularly, the modified starches after HCFT in Example 2-1 showed the most changes. Specifically, the modified starches after HCFT showed high final viscosity (FV) and peak viscosity (PV) values and low breakdown viscosity (BV) and setback viscosity (SV) values compared to the modified starches after the other processing steps in Example 2-1.

In conclusion, the gum addition improved the pasting characteristics of the modified starches, and particularly, its effects were most pronounced for the the modified starches after HCFT in Example 2-1, which is attributed to the coatability of the gum and the 4-dimensional starch-water-gum interactions (Table 4).

TABLE 4

| Sample | | | PV | BV | FV | SB | PTemp |
|---|---|---|---|---|---|---|---|
| Without gum | | Native | 8200 | 6178 | 2773 | 751 | 65.35 |
| | | (untreated control native starch) | | | | | |
| | | FT (third control) | 7327 | 6334 | 2598 | 1605 | 67.7 |
| | | HC (Example 1-1) | 7784 | 4431 | 3878 | 525 | 70.3 |
| | | HCFT (Example 1-1) | 8012 | 4511 | 3930 | 429 | 70.3 |
| XT | 0.1% | Mix-dry (first control) | 6696 | 4812 | 3011 | 1127 | 66.95 |
| | | FT (second control) | 6452 | 4333 | 2930 | 811 | 67.1 |
| | | HC (Example 2-1) | 5230 | 1800 | 3949 | 519 | 70.9 |
| | | HCFT (Example 2-1) | 6899 | 2622 | 4499 | 262 | 71.3 |
| | 0.3% | Mix-dry (first control) | 4831 | 2903 | 2989 | 1061 | 67.8 |
| | | FT (second control) | 4152 | 2710 | 2400 | 958 | 67.85 |
| | | HC (Example 2-1) | 4391 | 900 | 4010 | 519 | 71.8 |
| | | HCFT (Example 2-1) | 5515 | 1100 | 4545 | 130 | 71.85 |
| CMC | 0.1% | Mix-dry (first control) | 4534 | 2464 | 2999 | 929 | 67.15 |
| | | FT (second control) | 4403 | 2377 | 2889 | 863 | 67.8 |
| | | HC (Example 2-1) | 4824 | 1800 | 3909 | 685 | 69.55 |
| | | HCFT (Example 2-1) | 5900 | 1900 | 4400 | 400 | 70.35 |
| | 0.3% | Mix-dry (first control) | 3494 | 1397 | 2732 | 635 | 67 |
| | | FT (second control) | 3036 | 1024 | 2631 | 619 | 67.05 |
| | | HC (Example 2-1) | 3358 | 261 | 3650 | 553 | 70.3 |
| | | HCFT (Example 2-1) | 4200 | 280 | 4210 | 290 | 71.1 |
| GA | 0.1% | Mix-dry (first control) | 7493 | 5232 | 3322 | 1061 | 66.3 |
| | | FT (second control) | 6475 | 4377 | 2979 | 881 | 66.9 |
| | | HC (Example 2-1) | 6909 | 3489 | 3939 | 519 | 69.55 |
| | | HCFT (Example 2-1) | 7510 | 3717 | 4119 | 426 | 70.25 |
| | 0.3% | Mix-dry (first control) | 7352 | 4597 | 3535 | 780 | 65 |
| | | FT (second control) | 5107 | 3101 | 2616 | 610 | 66.35 |
| | | HC (Example 2-1) | 5849 | 2109 | 4010 | 470 | 71 |
| | | HCFT (Example 2-1) | 6616 | 2291 | 4577 | 352 | 72 |
| GG | 0.1% | Mix-dry (first control) | 7413 | 5132 | 2989 | 708 | 66.25 |
| | | FT (second control) | 7318 | 4900 | 3111 | 693 | 67.75 |
| | | HC (Example 2-1) | 7084 | 3910 | 3708 | 534 | 68.65 |
| | | HCFT (Example 2-1) | 8518 | 4265 | 4499 | 246 | 70.35 |
| | 0.3% | Mix-dry (first control) | 7005 | 5049 | 2434 | 478 | 65.4 |
| | | FT (second control) | 7105 | 4885 | 2662 | 442 | 67.15 |
| | | HC (Example 2-1) | 6452 | 3200 | 3632 | 380 | 69.5 |
| | | HCFT (Example 2-1) | 7826 | 3600 | 4400 | 174 | 70.25 |

2-2-5: Textures of the Control Starch Gel and the Modified Starch Gels

The textures of the starch gels were measured using a texture analyzer (TA) (TA-XT2, Stable Micro Systems, Surrey, UK). The hardness, springiness, cohesiveness, and chewiness values of the gum-added modified starch gels after Mix-dry, HC, HCFT, and FT (second control) were markedly improved compared to the native starch gel without gum. Particularly, the characteristics of the modified starch gel after HCFT in Example 2-1 were most improved. These results demonstrate that the gum addition was highly effective in improving the quality of the starch gels compared to without gum.

Particularly, the xanthan gum (XT)-added modified starch gels and the gum arabic (GA)-added modified starch gels after HCFT showed the highest hardness and chewiness values among the other gum-added modified starch gels after Mix-dry, HC, and FT (second control). The highest quality was obtained when the addition of 0.3% xanthan and 0.3% gum arabic. The gum-added modified starch gels showed good and stable textures compared to the starch gels without gum (Table 5).

TABLE 5

| | | Sample | Hardness (g) | Sgringness (mm) | Cohesiveness | Chewiness (g) |
|---|---|---|---|---|---|---|
| Without gum | | Native (untreated | 201.40 ± 5.68 | 0.86 ± 0.01 | 0.85 ± 0.00 | 144.18 ± 1.34 |
| | | control native starch) | | | | |
| | | FT (third control) | 178.00 ± 5.98 | 0.83 ± 0.02 | 0.85 ± 0.00 | 138.02 ± 8.11 |
| | | HC (Example 1-1) | 348.33 ± 9.72 | 0.87 ± 0.01 | 0.92 ± 0.01 | 263.06 ± 5.98 |
| | | HCFT (Example 1-1) | 397.04 ± 24.75 | 0.92 ± 0.01 | 0.93 ± 0.01 | 331.06 ± 7.01 |
| XT | 0.1% | Mix-dry (first control) | 235.93 ± 6.45 | 0.88 ± 0.02 | 0.87 ± 0.01 | 155.19 ± 5.10 |
| | | FT (second control) | 213.20 ± 2.77 | 0.90 ± 0.02 | 0.88 ± 0.00 | 150.38 ± 9.69 |
| | | HC (Example 2-1) | 320.10 ± 5.14 | 0.91 ± 0.01 | 0.85 ± 0.01 | 228.12 ± 5.27 |
| | | HCFT (Example 2-1) | 446.80 ± 3.06 | 0.96 ± 0.00 | 0.92 ± 0.01 | 402.29 ± 16.15 |
| | 0.3% | Mix-dry (first control) | 231.40 ± 12.13 | 0.89 ± 0.02 | 0.88 ± 0.00 | 185.16 ± 15.04 |
| | | FT (second control) | 239.87 ± 0.58 | 0.90 ± 0.01 | 0.85 ± 0.01 | 183.75 ± 6.28 |
| | | HC (Example 2-1) | 411.30 ± 12.00 | 0.95 ± 0.01 | 0.87 ± 0.05 | 384.71 ± 14.47 |
| | | HCFT (Example 2-1) | 511.00 ± 12.00 | 0.98 ± 0.00 | 0.94 ± 0.01 | 496.92 ± 13.04 |
| CMC | 0.1% | Mix-dry (first control) | 162.77 ± 0.89 | 0.84 ± 0.00 | 0.85 ± 0.00 | 109.47 ± 0.95 |
| | | FT (second control) | 156.30 ± 5.37 | 0.87 ± 0.02 | 0.84 ± 0.02 | 105.49 ± 1.37 |
| | | HC (Example 2-1) | 304.70 ± 4.56 | 0.92 ± 0.00 | 0.90 ± 0.01 | 206.10 ± 14.42 |
| | | HCFT (Example 2-1) | 387.07 ± 6.70 | 0.95 ± 0.01 | 0.92 ± 0.02 | 314.86 ± 8.01 |
| | 0.3% | Mix-dry (first control) | 221.33 ± 2.52 | 0.87 ± 0.01 | 0.85 ± 0.01 | 151.78 ± 6.23 |
| | | FT (second control) | 207.64 ± 4.54 | 0.88 ± 0.01 | 0.86 ± 0.01 | 141.15 ± 7.74 |
| | | HC (Example 2-1) | 320.23 ± 10.40 | 0.92 ± 0.01 | 0.88 ± 0.07 | 216.71 ± 32.59 |
| | | HCFT (Example 2-1) | 402.33 ± 6.66 | 0.95 ± 0.01 | 0.95 ± 0.06 | 387.37 ± 6.47 |
| GA | 0.1% | Mix-dry (first control) | 224.83 ± 2.78 | 0.86 ± 0.01 | 0.87 ± 0.01 | 183.76 ± 7.03 |
| | | FT (second control) | 228.63 ± 8.87 | 0.86 ± 0.01 | 0.89 ± 0.01 | 197.33 ± 2.08 |
| | | HC (Example 2-1) | 367.30 ± 2.82 | 0.94 ± 0.00 | 0.88 ± 0.03 | 280.19 ± 15.04 |
| | | HCFT (Example 2-1) | 478.57 ± 8.17 | 0.98 ± 0.01 | 0.93 ± 0.01 | 353.14 ± 12.85 |
| | 0.3% | Mix-dry (first control) | 241.23 ± 3.28 | 0.85 ± 0.01 | 0.88 ± 0.01 | 169.96 ± 12.97 |
| | | FT (second control) | 206.50 ± 4.70 | 0.85 ± 0.03 | 0.88 ± 0.01 | 185.67 ± 5.86 |
| | | HC (Example 2-1) | 472.03 ± 2.27 | 0.97 ± 0.01 | 0.92 ± 0.00 | 418.55 ± 6.37 |
| | | HCFT (Example 2-1) | 516.27 ± 1.27 | 0.98 ± 0.01 | 0.93 ± 0.00 | 492.27 ± 8.79 |
| GG | 0.1% | Mix-dry (first control) | 205.97 ± 4.64 | 0.85 ± 0.01 | 0.84 ± 0.03 | 155.89 ± 1.21 |
| | | FT (second control) | 218.50 ± 8.35 | 0.88 ± 0.01 | 0.88 ± 0.02 | 199.86 ± 5.56 |
| | | HC (Example 2-1) | 358.80 ± 5.88 | 0.93 ± 0.01 | 0.91 ± 0.00 | 261.93 ± 11.20 |
| | | HCFT (Example 2-1) | 389.90 ± 9.36 | 0.97 ± 0.00 | 0.94 ± 0.01 | 343.39 ± 9.60 |
| | 0.3% | Mix-dry (first control) | 213.83 ± 6.64 | 0.86 ± 0.01 | 0.87 ± 0.02 | 174.00 ± 5.20 |
| | | FT (second control) | 204.90 ± 7.25 | 0.88 ± 0.01 | 0.89 ± 0.01 | 177.19 ± 10.72 |
| | | HC (Example 2-1) | 358.33 ± 2.89 | 0.93 ± 0.01 | 0.91 ± 0.01 | 297.59 ± 1.16 |
| | | HCFT (Example 2-1) | 413.85 ± 2.26 | 0.97 ± 0.01 | 0.96 ± 0.02 | 394.47 ± 5.07 |

2-2-6: Storage Stability of the Control Starch Gel and the Modified Starch Gels (Syneresis During Storage)

The syneresis values of the gum-added modified starch gels after Mix-dry, HC, HCFT, and FT (second control) during storage were much lower than those of the gum-free gels. The high syneresis indicates high storage stability.

The control native starch showed a syneresis of 56.37% after one cycle of freezing-thawing and syneresis values as high as 58.31%, 63.84%, 69.85%, and 72.22% after 2-5 cycles of freezing-thawing, respectively. These results demonstrate very low storage stability of the control native starch.

Much lower syneresis values were obtained when the gums were added compared to when none of the gums were added.

When the xanthan gum (XT) was added, the highest syneresis values were obtained after 1-5 cycles of freezing-thawing. The CMC addition showed a similar syneresis tendency to the gum arabic (GA) addition. When the guar gum was added, the lowest syneresis values (%) were obtained. Increases in syneresis were observed after 1-5 cycles of freezing-thawing. As a result, the smallest increase in syneresis was observed for the xanthan gum addition and the largest increase in syneresis was observed for the guar gum addition. Particularly, the lowest syneresis values (%) were observed in the modified starch gels after HCFT.

When the xanthan gum was added, syneresis values (%) of 37.19% (0.1% gum added) and 32.15% (0.3% gum added) were obtained after one cycle of freezing-thawing. When the CMC was added, syneresis values (%) of 32.04% (0.1% gum added) and 27.38% (0.3% gum added) were obtained after one cycle of freezing-thawing. When the gum arabic was added, syneresis values (%) of 30.00% (0.1% gum added) and 20.00% (0.3% gum added) were obtained after one cycle of freezing-thawing. When the guar gum was added, syneresis values (%) of 15.02% (0.1% gum added) and 16.61% (0.3% gum added) were obtained after one cycle of freezing-thawing. When the xanthan gum was added, syneresis values (%) of 47.64% (0.1% gum added) and 43.91% (0.3% gum added) were obtained after 5 cycles of freezing-thawing. When the CMC was added, syneresis values (%) of 47.52% (0.1% gum added) and 43.09% (0.3% gum added) were obtained after 5 cycles of freezing-thawing. When the gum arabic was added, syneresis values (%) of 46.41% (0.1% gum added) and 42.89% (0.3% gum added) were obtained after 5 cycles of freezing-thawing. When the guar gum was added, syneresis values (%) of 43.88% (0.1% gum added) and 40.13% (0.3% gum added) were obtained after 5 cycles of freezing-thawing (Table 6).

TABLE 6

| | | | Synersis(%) | | | | |
|---|---|---|---|---|---|---|---|
| Sample | | | 1 cycle | 2 cycle | 3 cycle | 4 cycle | 5 cycle |
| Without gum | | Native | 56.37 | 58.21 | 63.84 | 69.85 | 72.22 |
| | | (untreated control native starch) | | | | | |
| | | FT (third control) | 53.41 | 55.79 | 60.39 | 63.03 | 67.68 |
| | | HC (Example 1-1) | 48.29 | 49.88 | 50.38 | 52.34 | 54.56 |
| | | HCFT (Example 1-1) | 42.22 | 45.59 | 45.70 | 49.32 | 50.56 |
| XT | 0.1% | Mix-dry (first control) | 52.11 | 53.23 | 55.31 | 56.51 | 56.61 |
| | | FT (second control) | 47.39 | 49.40 | 52.58 | 55.61 | 55.92 |
| | | HC (Example 2-1) | 46.25 | 47.69 | 48.52 | 53.30 | 55.01 |
| | | HCFT (Example 2-1) | 37.19 | 41.75 | 43.29 | 47.43 | 47.64 |
| | 0.3% | Mix-dry (first control) | 50.25 | 52.61 | 54.18 | 55.07 | 55.22 |
| | | FT (second control) | 45.14 | 47.61 | 50.24 | 52.80 | 53.80 |
| | | HC (Example 2-1) | 43.03 | 45.00 | 47.43 | 50.74 | 54.23 |
| | | HCFT (Example 2-1) | 32.15 | 41.60 | 42.60 | 43.56 | 43.91 |
| CMC | 0.1% | Mix-dry (first control) | 55.19 | 57.65 | 57.95 | 60.26 | 61.18 |
| | | FT (second control) | 43.96 | 50.16 | 50.84 | 53.01 | 54.35 |
| | | HC (Example 2-1) | 42.74 | 48.29 | 48.33 | 52.51 | 52.73 |
| | | HCFT (Example 2-1) | 32.04 | 39.07 | 41.83 | 45.58 | 47.52 |
| | 0.3% | Mix-dry (first control) | 54.67 | 55.80 | 55.98 | 58.86 | 58.89 |
| | | FT (second control) | 34.36 | 46.95 | 48.06 | 51.47 | 53.93 |
| | | HC (Example 2-1) | 33.85 | 45.13 | 45.55 | 50.47 | 51.77 |
| | | HCFT (Example 2-1) | 27.38 | 37.27 | 38.61 | 42.66 | 43.09 |
| GA | 0.1% | Mix-dry (first control) | 48.73 | 51.78 | 53.01 | 58.79 | 62.09 |
| | | FT (second control) | 46.70 | 49.83 | 51.75 | 55.02 | 57.69 |
| | | HC (Example 2-1) | 38.91 | 45.12 | 47.77 | 52.92 | 52.61 |
| | | HCFT (Example 2-1) | 30.00 | 35.36 | 39.78 | 46.93 | 46.41 |
| | 0.3% | Mix-dry (first control) | 48.54 | 50.23 | 52.26 | 57.38 | 60.23 |
| | | FT (second control) | 45.06 | 47.13 | 49.24 | 53.63 | 54.02 |
| | | HC (Example 2-1) | 37.18 | 44.41 | 47.54 | 52.15 | 51.86 |
| | | HCFT (Example 2-1) | 25.00 | 33.28 | 33.67 | 42.75 | 42.98 |
| GG | 0.1% | Mix-dry (first control) | 45.62 | 51.68 | 52.13 | 59.00 | 60.69 |
| | | FT (second control) | 39.39 | 48.10 | 49.27 | 56.15 | 57.83 |
| | | HC (Example 2-1) | 33.72 | 46.23 | 46.72 | 51.20 | 52.63 |
| | | HCFT (Example 2-1) | 15.02 | 36.85 | 39.48 | 42.11 | 43.88 |
| | 0.3% | Mix-dry (first control) | 30.12 | 48.03 | 50.32 | 57.43 | 59.42 |
| | | FT (second control) | 23.37 | 46.46 | 49.01 | 54.12 | 55.75 |
| | | HC (Example 2-1) | 19.57 | 43.31 | 44.26 | 50.32 | 51.40 |
| | | HCFT (Example 2-1) | 16.61 | 32.91 | 33.55 | 39.55 | 40.13 |

Although the particulars of the present disclosure have been described in detail, it will be obvious to those skilled in the art that such particulars are merely preferred embodiments and are not intended to limit the scope of the present invention. Therefore, the true scope of the present invention is defined by the appended claims and their equivalents.

### INDUSTRIAL APPLICABILITY

The method of the present invention enables the preparation of a modified starch based on a simple modification. The use of the modified starch greatly contributes to improvements in the quality and storage stability of various starchy foods. Therefore, the modified starch is expected to find application in the food industry, including starchy foods.

1. A method for preparing a modified starch comprising (a) heating a starch or a starch-gum mixture obtained by adding a gum to a starch to a temperature at which no gelatinization of the starch occurs, (b) cooling the heated starch or starch-gum mixture, (c) freezing the cooled starch or starch-gum mixture and thawing the frozen starch or starch-gum mixture at room temperature, and (d) drying the thawed starch or starch-gum mixture.

2. The method according to claim 1, wherein the starch is selected from the group consisting of corn starch, waxy corn starch, potato starch, tapioca starch, and mixtures thereof.

3. The method according to claim 1, wherein, in step (a), the starch or starch-gum mixture is heated at a temperature of 35 to 70° C. for 30 minutes to 12 hours.

4. The method according to claim 1, wherein, in step (c), the cooled starch or starch-gum mixture is frozen for at least 30 minutes.

5. The method according to claim 1, wherein, in step (c), the frozen starch or starch-gum mixture is thawed at a temperature of 5 to 70° C.

6. The method according to claim 1, wherein, in step (a), the starch is in the form of a dispersion in which 10 to 60% (w/w) of the starch is mixed with water.

7. The method according to claim 1, wherein, in step (d), the thawed starch or starch-gum mixture is dried at a temperature of 25 to 70° C.

8. The method according to claim 1, wherein, in step (d), the thawed starch or starch-gum mixture is dried by one or more processes selected from the group consisting of natural drying, freeze-drying, vacuum drying, and drying at constant temperature and humidity.

9. The method according to claim 1, wherein the gum is selected from the group consisting of xanthan gum, guar gum, gum arabic, and carboxymethyl cellulose.

10. The method according to claim 1, wherein, in step (a), the starch-gum mixture is prepared by directly mixing a starch with a gum or by adding a gum to distilled water, adding the gum solution to a starch to prepare a starch dispersion, and stirring the starch dispersion.

11. The method according to claim 1, wherein the starch-gum mixture comprises 0.1 to 10% (w/w) of the gum, based on the weight of the starch.

12. A modified starch prepared by the method according to claim 1.
